(19) United States
(12) Patent Application Publication
(10) Pub. No.: US 2024/0403649 A1
(43) Pub. Date: Dec. 5, 2024

(54) MODULARIZED ARCHITECTURE OPTIMIZATION FOR SEMI-SUPERVISED INCREMENTAL LEARNING

(71) Applicant: SRI International, Menlo Park, CA (US)

(72) Inventors: Han-Pang Chiu, West Windsor, NJ (US); Yi Yao, Princeton, NJ (US); Zachary Seymour, Pennington, NJ (US); Alex Krasner, Princeton, NJ (US); Bradley J. Clymer, Austin, TX (US); Michael A. Cogswell, West Windsor, NJ (US); Cecile Eliane Jeannine Mackay, Palo Alto, CA (US); Alex C. Tozzo, Philadelphia, PA (US); Tixiao Shan, Princeton Junction, NJ (US); Philip Miller, Yardley, PA (US); Chuanyong Gan, Plainsboro, NJ (US); Glenn A. Murray, Jamison, PA (US); Richard Louis Ferranti, San Carlos, CA (US); Uma Rajendran, Allentown, CA (US); Supun Samarasekera, Skillman, NJ (US); Rakesh Kumar, West Windsor, NJ (US); James Smith, Decatur, GA (US)

(21) Appl. No.: 18/520,800

(22) Filed: Nov. 28, 2023

Related U.S. Application Data
(60) Provisional application No. 63/447,559, filed on Feb. 22, 2023.
(60) Provisional application No. 63/385,319, filed on Nov. 29, 2022.

(51) Int. Cl. G06N 3/0895

(52) U.S. Cl. CPC G06N 3/0895

(57) ABSTRACT

In an example, a system includes processing circuitry in communication with storage media. The processing circuitry is configured to execute a machine learning system including at least a first module, a second module and a third module. The machine learning system is configured to train one or more machine learning models. The first module is configured to generate augmented input data based on the streaming input data. The second module includes a machine learning model configured to perform a specific task based at least in part on the augmented input data. The third module configured to adapt a network architecture of the one or more machine learning models based on changes in the streaming input data.

This application claims the benefit of U.S. Patent Application No. 63/385,319, filed Nov. 29, 2022, and of U.S. Patent Application No. 63/447,559, filed Feb. 22, 2023, each of which is incorporated by reference herein in its entirety.

### GOVERNMENT RIGHTS

This invention was made with Government support under Contract No. N65236-20-C-8020 awarded by the US Navy NIWC Atlantic Charleston. The Government has certain rights in this invention.

### TECHNICAL FIELD

This disclosure is related to machine learning systems.

### BACKGROUND

Machine learning models are typically trained offline on a large dataset because it is computationally expensive to train them on a real-time basis. The model is typically frozen offline for training to prevent it from overfitting to the training data. Overfitting occurs when the model learns the specific details of the training data too well, and as a result, it does not generalize well to new data. The model is then typically deployed in the real world with the assumption that the properties and distribution of online data in the real world is the same as the offline data. However, this is not always the case. The real-world data may be different from the offline data in a number of ways, such as the distribution of the data, the noise level, or the presence of outliers. When the real-world data is different from the offline data, the model may not perform well.

It may not always be possible to use a pre-trained model for real-world applications. Some domains, such as maritime, may be difficult for offline data collection and labeling because it may be expensive and time-consuming to collect data in these domains, and because it may be difficult to find experts to label the data. There are also less-explored or novel data modalities beyond vision (cameras). For example, in the medical domain, there is increasing interest in using data from medical imaging modalities such as Magnetic Resonance Imaging (MRI) and Computerized Tomography (CT) scans. However, there are not many pre-trained models available for these data modalities.

### SUMMARY

In general, the disclosure describes techniques that use a machine learning framework with several new capabilities, including, but not limited to, few-shot learning, hybrid replay method, and architecture optimization method. Few-shot learning is a technique that allows a machine learning model to learn a new task or otherwise be trained with only a few examples. Few-shot learning is useful in real-world applications where it is difficult to collect a large amount of labeled data. Few-shot learning is in contrast to traditional machine learning, where the model is trained on a large number of examples. Few-shot learning is becoming increasingly important as the amount of data available for training machine learning models continues to grow.

Hybrid replay method may be implemented by a hybrid replay module, which may address the problem of class imbalance by generating augmentation samples of the class with limited available real examples. The hybrid replay module may help to improve the performance of the machine learning model on the imbalanced class. The hybrid replay module is a technique that addresses the problem of class imbalance. Class imbalance occurs when there are more examples of one class than another. Class imbalance may make it difficult for a machine learning model to learn to classify the minority class accurately. Architecture optimization method may be implemented by an architecture optimization module, which may automatically adapt the system's complexity based on evolved sensor data for inference. The architecture optimization module may help to improve the performance of the machine learning model over time. The architecture optimization module may automatically adapt the system's complexity based on evolved sensor data for inference.

The techniques may provide one or more technical advantages that realize at least one practical application. For example, the hybrid replay module may help to improve the performance of the machine learning model on the imbalanced class. A task-specific network may allow the machine learning model to be trained on a small number of examples. Some of the benefits of the disclosed techniques may be useful in real-world applications where it is difficult to collect a large amount of labeled data. The architecture optimization module may automatically adapt the system's complexity based on evolved sensor data for inference. The architecture optimization module may help to improve the performance of the machine learning model over time.

The combination of the aforementioned processing components may be used to train a machine learning model(s), such as, but not limited to neural networks, using live streaming data. Live streaming data is a relatively new concept that has the potential to improve the performance of machine learning models in real-world applications. Some additional benefits of the combination of the disclosed processing components may include, but are not limited to: real-time inference, scalability and robustness. Advantageously, the machine learning model may be trained and deployed in real time, which may be important for many real-world applications. The disclosed techniques may be scaled to handle large amounts of data. The disclosed techniques are also robust to changes in the data distribution.

In an example, a system includes processing circuitry in communication with storage media. The processing circuitry is configured to execute a machine learning system comprising at least a first module, a second module and a third module. The machine learning system is configured to train one or more machine learning models. The first module is configured to generate augmented input data based on the streaming input data. The second module comprises a machine learning model configured to perform a specific task based at least in part on the augmented input data. The third module configured to adapt a network architecture of the one or more machine learning models based on changes in the streaming input data.

In an example, a method includes, generating, using a first module, augmented input data based on streaming input data; performing, using a second module comprising a machine learning model, a specific task based at least in part on the augmented input data; and adapting, using a third module, a network architecture of the one or more machine learning models based on changes in the streaming input data.

In an example, non-transitory computer-readable storage media having instructions encoded thereon, the instructions configured to cause processing circuitry to: generate, using a first module, augmented input data based on streaming input data; perform, using a second module comprising a machine learning model, a specific task based at least in part on the augmented input data; and adapt, using a third module, a network architecture of the one or more machine learning models based on changes in the streaming input data.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram illustrating an example system in accordance with the techniques of the disclosure.

FIG. 2 is a conceptual diagram illustrating an example semi-supervised incremental learning according to techniques of this disclosure.

FIGS. 3 is a conceptual diagram illustrating an example hybrid reply method according to techniques of this disclosure.

FIG. 4 is a conceptual diagram illustrating an example architecture optimization method according to techniques of this disclosure.

FIG. 5 is a conceptual diagram illustrating an example incremental Differentiable Architecture Search (DARTS) optimization method according to techniques of this disclosure.

FIG. 6 is a flowchart illustrating an example mode of operation for a hybrid replay module, according to techniques described in this disclosure.

FIG. 7 is a flowchart illustrating an example mode of operation for an architecture optimization module, according to techniques described in this disclosure

FIG. 8 is an example diagram of a distributed data processing system in which aspects of the illustrative technique may be implemented.

Like reference characters refer to like elements throughout the figures and description.

### DETAILED DESCRIPTION

Traditional machine learning approaches typically require a large amount of labeled data to train a model. The labeled data is often collected offline, and the model is then deployed in the real world.

However, traditional machine learning techniques have several limitations. It is not practical to collect a large amount of labeled data in all domains, such as naval, space, and underwater domains. There are many emerging data modalities, such as RF signals, radar, and Synthetic Aperture Radar (SAR), for which there is limited labeled data available. The data of the same class may evolve over time, so a model trained on offline data may not perform well on new data. Using a single pre-trained model for all applications is not always feasible, as each application may have its own unique requirements.

The present disclosure describes a new machine learning framework that addresses the aforementioned challenges. The disclosed framework is designed to train and deploy machine learning models in real time using live streaming data.

In an aspect, the disclosed framework may use a combination of three processing modules to achieve this. The three processing modules may include, but are not limited to: a hybrid replay module, task-specific module and architecture optimization module.

A hybrid replay module may address the problem of limited labeled data by generating augmentation samples of the minority class. A task-specific network module may allow the machine learning model to be trained on a small number of examples. An architecture optimization module may automatically adapt the system's complexity based on evolved sensor data for inference. Advantageously, the combination of the aforementioned three processing modules may allow the framework to train machine learning models for real-world applications without the need for a large amount of offline labeled data. Following are some examples of how the disclosed framework could be used in real-world applications.

As an example, the disclosed framework could be used to train a model to detect and track ships in real time using radar data. As another example, the disclosed framework could be used to train a model to identify and classify objects in real time using satellite imagery. As yet another example, the disclosed framework could be used to train a model to classify types of fish in real time using underwater video footage.

In accordance with techniques of this disclosure, the present disclosure describes a new approach to training machine learning models in real time using live streaming data, even when there is limited or no offline training data available. The disclosed technique is known as in-situ algorithm training. In-situ algorithm training has several advantages over traditional machine learning techniques.

The in-situ algorithm training may be faster and more efficient, as the model is trained on live data as it is generated. The in-situ algorithm training may be more robust to changes in the data distribution, as the model is constantly being updated with new data. The in-situ algorithm training may be used to train models for applications where offline training data is not available or is impractical to collect.

The present disclosure also describes a hybrid replay module that is used to address the problem of class imbalance in live streaming data. Class imbalance may occur when there are more examples of one class than another. Class imbalance may make it difficult for a machine learning model to learn to classify the minority class accurately. In an aspect, the hybrid replay module may work by generating augmentation samples of the minority class. In an aspect, such augmentation samples of the minority class may be generated by using techniques such as, but not limited to, data augmentation or synthetic data generation. The augmentation samples may then be added to the training dataset, which may help to improve the performance of the model on the minority class.

The present disclosure also describes an architecture optimization module that may be used to automatically adapt the system's complexity based on evolved sensor data for inference. Such adaptation may help to ensure that the model is always using the optimal amount of resources to achieve the desired level of accuracy. Overall, the present disclosure describes a promising new approach to training machine learning models in real time using live streaming data. The disclosed techniques have the potential to revolutionize the way that machine learning is used in many different applications. Following are some examples of how in-situ algorithm training could be used in real-world applications. In-situ algorithm training could be used to train a model to detect fraudulent transactions in real time using live data from financial institutions. The in-situ algorithm training could be used to train a model to diagnose diseases in real time using live data from medical devices. The in-situ algorithm training could also be used to train a model to predict when machines are likely to fail using live data from sensors on the machines.

In an aspect, the data pre-processing module may be an optional component of a machine learning pipeline that is responsible for preparing the data for training and evaluation. The data pre-processing module may provide an interface to three major functions: format transformation, metadata derivation, and data association. The format transformation function may convert the data into a format that is compatible with the machine learning algorithm that may be used to train the model(s).

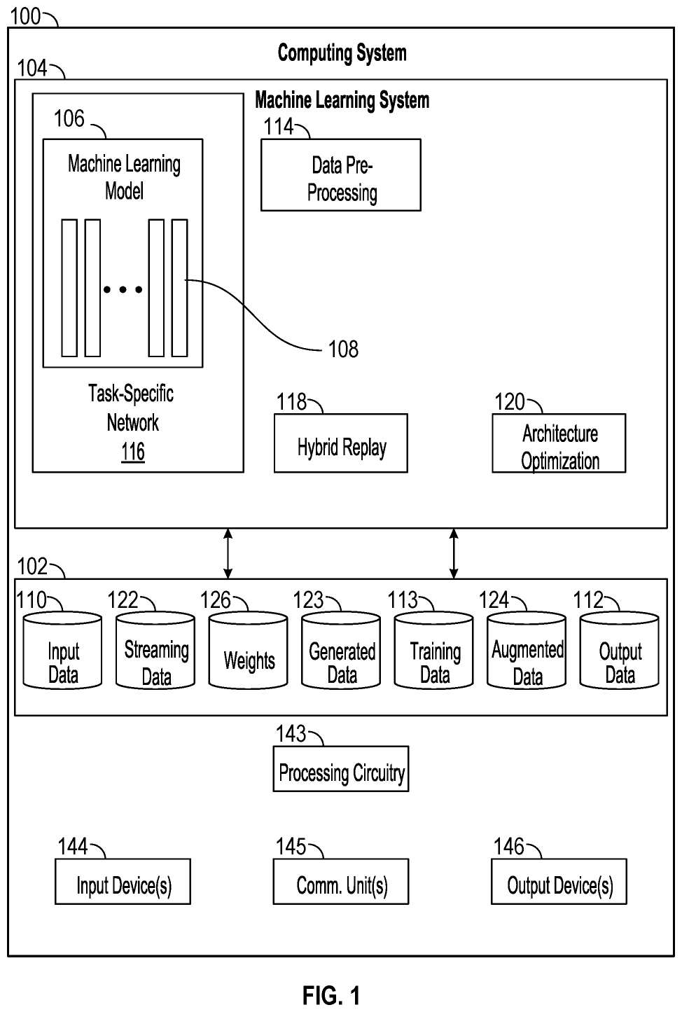

FIG. 1 is a block diagram illustrating an example computing system 100. As shown, computing system 100 comprises processing circuitry 143 and memory 102 for executing a machine learning system 104 having one or more modules, including but not limited to data pre-processing module 114, task-specific network module 116, hybrid replay module 118, and architecture optimization module 120. In addition, the task-specific module 116 may include one or more machine learning models 106. The ML model 106 may comprise various types of neural networks, such as, but not limited to, recursive neural networks (RNNs), convolutional neural networks (CNNs) and deep neural networks (DNNs).

Computing system 100 may be implemented as any suitable computing system, such as one or more server computers, workstations, laptops, mainframes, appliances, cloud computing systems, High-Performance Computing (HPC) systems (i.e., supercomputing) and/or other computing systems that may be capable of performing operations and/or functions described in accordance with one or more aspects of the present disclosure. In some examples, computing system 100 may represent a cloud computing system, server farm, and/or server cluster (or portion thereof) that provides services to client devices and other devices or systems. In other examples, computing system 100 may represent or be implemented through one or more virtualized compute instances (e.g., virtual machines, containers, etc.) of a data center, cloud computing system, server farm, and/or server cluster.

The techniques described in this disclosure may be implemented, at least in part, in hardware, software, firmware or any combination thereof. For example, various aspects of the described techniques may be implemented within processing circuitry 143 of computing system 100, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. Processing circuitry 143 of computing system 100 may implement functionality and/or execute instructions associated with computing system 100. Computing system 100 may use processing circuitry 143 to perform operations in accordance with one or more aspects of the present disclosure using software, hardware, firmware, or a mixture of hardware, software, and firmware residing in and/or executing at computing system 100. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

In another example, computing system 100 comprises any suitable computing system having one or more computing devices, such as desktop computers, laptop computers, gaming consoles, smart televisions, handheld devices, tablets, mobile telephones, smartphones, etc. In some examples, at least a portion of system 100 is distributed across a cloud computing system, a data center, or across a network, such as the Internet, another public or private communications network, for instance, broadband, cellular, Wi-Fi, ZigBee, Bluetooth® (or other personal area network-PAN), Near-Field Communication (NFC), ultrawideband, satellite, enterprise, service provider and/or other types of communication networks, for transmitting data between computing systems, servers, and computing devices.

Memory 102 may comprise one or more storage devices. One or more components of computing system 100 (e.g., processing circuitry 143, memory 102, data pre-processing module 114, task-specific network module 116, hybrid replay module 118, and architecture optimization module 120) may be interconnected to enable inter-component communications (physically, communicatively, and/or operatively). In some examples, such connectivity may be provided by a system bus, a network connection, an inter-process communication data structure, local area network, wide area network, or any other method for communicating data. The one or more storage devices of memory 102 may be distributed among multiple devices.

Memory 102 may store information for processing during operation of computing system 100. In some examples, memory 102 comprises temporary memories, meaning that a primary purpose of the one or more storage devices of memory 102 is not long-term storage. Memory 102 may be configured for short-term storage of information as volatile memory and therefore not retain stored contents if deactivated. Examples of volatile memories include random access memories (RAM), dynamic random-access memories (DRAM), static random access memories (SRAM), and other forms of volatile memories known in the art. Memory 102, in some examples, may also include one or more computer-readable storage media. Memory 102 may be configured to store larger amounts of information than volatile memory. Memory 102 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 102 may store program instructions and/or data associated with one or more of the modules described in accordance with one or more aspects of this disclosure.

Processing circuitry 143 and memory 102 may provide an operating environment or platform for one or more modules or units (e.g., data pre-processing module 114, task-specific network module 116, hybrid replay module 118, and architecture optimization module 120), which may be implemented as software, but may in some examples include any combination of hardware, firmware, and software. Processing circuitry 143 may execute instructions and the one or more storage devices, e.g., memory 102, may store instructions and/or data of one or more modules. The combination of processing circuitry 143 and memory 102 may retrieve, store, and/or execute the instructions and/or data of one or more applications, modules, or software. The processing circuitry 143 and/or memory 102 may also be operably coupled to one or more other software and/or hardware components, including, but not limited to, one or more of the components illustrated in FIG. 1.

Processing circuitry 143 may execute machine learning system 104 using virtualization modules, such as a virtual machine or container executing on underlying hardware. One or more of such modules may execute as one or more services of an operating system or computing platform. Aspects of machine learning system 104 may execute as one or more executable programs at an application layer of a computing platform.

One or more input devices 144 of computing system 100 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output devices 146 may generate, transmit, or process output. Examples of output are tactile, audio, visual, and/or video output. Output devices 146 may include a display, sound card, video graphics adapter card, speaker, presence-sensitive screen, one or more USB interfaces, video and/or audio output interfaces, or any other type of device capable of generating tactile, audio, video, or other output. Output devices 146 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 100 may include a presence-sensitive display that may serve as a user interface device that operates both as one or more input devices 144 and one or more output devices 146.

One or more communication units 145 of computing system 100 may communicate with devices external to computing system 100 (or among separate computing devices of computing system 100) by transmitting and/or receiving data, and may operate, in some respects, as both an input device and an output device. In some examples, communication units 145 may communicate with other devices over a network. In other examples, communication units 145 may send and/or receive radio signals on a radio network such as a cellular radio network. Examples of communication units 145 may include a network interface card (e.g., such as an Ethernet card), an optical transceiver, a radio frequency transceiver, a GPS receiver, or any other type of device that can send and/or receive information. Other examples of communication units 145 may include Bluetooth®, GPS, 3G, 4G, and Wi-Fi® radios found in mobile devices as well as Universal Serial Bus (USB) controllers and the like.

In the example of FIG. 1, data pre-processing module 114 may receive input data from an input data set 110 and may generate output data 112. Input data 110 and output data 112 may contain various types of information. For example, input data 110 may include live streaming transaction data (streaming data 122). Further, data pre-processing component 114 may output the streaming data 122 to integrate with generated data 123 (outputted from hybrid replay 118) to generate augmented data 124, destined for task-specific network module 116 and architecture optimization module 120. Task specific network module 116 may output interference output (e.g., classification, detection, recognition, segmentation, or prediction), which may be part of output data 112.

As noted above, the ML model 106 may comprise various types of neural networks, such as, but not limited to, RNNs, CNNs and DNNs comprising a corresponding set of layers. Each set of layers 108 may include a respective set of artificial neurons. The layers 108 for example, may include an input layer, a feature layer, an output layer, and one or more hidden layers. The layers 108 may include fully connected layers, convolutional layers, pooling layers, and/or other types of layers. In a fully connected layer, the output of each neuron of a previous layer forms an input of each neuron of the fully connected layer. In a convolutional layer, each neuron of the convolutional layer processes input from neurons associated with the neuron's receptive field. Pooling layers combine the outputs of neuron clusters at one layer into a single neuron in the next layer.

Each input of each artificial neuron in each layer of the sets of layers may be associated with a corresponding weight in weights 126. Various activation functions are known in the art, such as Rectified Linear Unit (ReLU), TanH, Sigmoid, and so on.

ML system 104 may process training data 113 to train the ML model 106, in accordance with techniques described herein. For example, machine learning system 104 may apply an end-to-end training method that includes processing training data 113. Machine learning system 104 may process input data 110, which may include streaming data 122 to generate inference data (output data 112) as described below.

In an aspect, machine learning system 104 may generate rapid and correct results while overcoming potential class imbalance issues presented by input data 110. The machine learning system 104 may be configured to be used for real-world applications, where the live streaming data 122 can evolve over time. The data pre-processing module 114 may transform the live streaming data 122 into a format that is compatible with the machine learning algorithm that will be used to train the ML model 106. The data pre-processing module 114 may also extract metadata from the input data 110. In an aspect, the task-specific network module 116 may be a machine learning model configured to perform a specific task, such as, but not limited to, classifying images, detecting objects, generating images or generating text. The task-specific network module 116 may be trained using a combination of few-shot learning techniques, semi-supervised learning, and self-supervised learning. Such training techniques may allow the task-specific network module 116 to learn to perform the task accurately, even when there is limited training data 113 available.

In an aspect, the hybrid replay module 118 may be configured to use a combination of selective memory and a generative network to augment the real streaming data 122. The hybrid replay module 118 may help to address the problem of class imbalance and may prevent the machine learning models 106 from overfitting to the training data 113.

In an aspect, the architecture optimization module 120 may be configured to adapt the network architecture of the task-specific network 116 and to adapt replay mode based on the ever-increasing complexity of the streaming data 122. The architecture optimization module 120 may help to improve the accuracy of the output of the ML model 106.

In summary, the machine learning system 104 may be configured to first pre-process the live streaming data 122. In an aspect, the data pre-processing module 114 may convert the input data 110 into a format that is compatible with the task-specific network module 116 and may extract metadata from the input data 110. The task-specific network module 116 may then be trained on the pre-processed data using a combination of few-shot learning techniques, semi-supervised learning, and self-supervised learning. The hybrid replay module 118 may then be used to augment the real streaming data 122 and may generate the augmented data 124. The hybrid replay module 118 may help to address the problem of class imbalance and may prevent the ML model 106 from overfitting to the training data 113. Finally, the architecture optimization module 120 may adapt the network architecture of the task-specific network module 116 and may adapt replay mode based on the ever-increasing complexity of the streaming data 122. The architecture optimization module 120 may help to improve the accuracy of the output of the ML model 106.

The described machine learning system 104 may have a number of advantages over traditional machine learning techniques. The machine learning system 104 may generate rapid and correct results, even when there is limited or no training data 113 available. As another advantage, the machine learning system 104 may be robust to class imbalance and may avoid overfitting to the training data 113. As yet another advantage, the machine learning system 104 may be able to adapt to changes in the data distribution over time.

In an aspect, the disclosed techniques make the machine learning system 104 well-suited for real-world applications, such as, but not limited to, fraud detection, medical diagnosis, and predictive maintenance. The machine learning system 104 could be used to train the ML model 106 to detect fraudulent transactions in real time using live input data 110 (e.g., streaming data 122) from financial institutions. The machine learning system 104 could be used to train the ML model 106 to diagnose diseases in real time using live input data 110 from medical devices. As yet another non-limiting example, the machine learning system 104 could be used to train the ML model 106 to predict when machines are likely to fail using live input data 110 from sensors on the machines.

Advantageously, the combination of the hybrid replay module 118, task-specific network module 116, and the architecture optimization module 120 to train the ML model 106 using live streaming data is a novel concept not currently known in the art. Traditional machine learning techniques typically require a large amount of labeled data to train a model. Such labeled data is often collected offline, and the model is then deployed in the real world.

However, traditional machine learning techniques have several limitations. For example, it may not be practical to collect a large amount of labeled data in all domains, such as naval, space, and underwater domains.

In accordance with techniques of this disclosure, the machine learning system 104 may have several new capabilities that address the challenges of training and deploying machine learning models in real-world applications. For example, few-shot learning is a technique that allows the machine learning system 104 to be trained on a small number of examples. This type of training may be useful for real-world applications where it is difficult or expensive to collect a large amount of labeled data. As another non-limiting example, the hybrid replay module 118 may implement hybrid replay technique which is a technique that addresses the problem of class imbalance. Class imbalance occurs when there are more examples of one class than another.

Advantageously, the technical aspects of the present disclosure allow a long-term learning system or an application in a new data domain to circumvent or minimize manual effort to collect large quantities of training data offline beforehand because the present disclosure describes a new machine learning framework that may train and deploy machine learning models in real time using live streaming data 122. As noted above, the disclosed framework uses a combination of three aforementioned techniques to achieve this: few shot learning, hybrid replay and architecture optimization. For example, class imbalance may make it difficult for the machine learning system 104 to learn to classify the minority class accurately. The hybrid replay technique works by generating augmentation samples of the minority class. Such augmentation samples may help to improve the performance of the model on the minority class. The architecture optimization technique automatically adapts the complexity of a machine learning model based on the data. Such optimization may be useful for real-world applications where the data distribution can change over time.

In an aspect, the data pre-processing module 114 may output streaming data 122 to integrate with generated data (reference #) (outputted from the hybrid replay module 118) to generate augmented data 124, destined for the task-specific network module 116 and the architecture optimization module 120. The architecture optimization module 120 may output selected component to both the hybrid replay module 118 and the task-specific network module 116. The task-specific network module 116 may use few-shot learning (also referred herein as “few-shot techniques”) for automatic result generation of new/unknown data by generalizing data and/or features from old data to determine new data. Using few-shot learning techniques allows the task-specific network module 116 to generate rapid and correct inference outputs in real-time after, e.g., a user labels a small amount of live-streaming data 122, thereby circumventing offline learning techniques previously known in the art. Confidence scores of the inference data may be outputted to the hybrid replay module 118.

Further, the task-specific network module 116 may be trained using live streaming input data with class imbalance. In an aspect, the techniques that may be used to overcome class imbalance in the live streaming input data may include, but are not limited to: self-supervised learning, semi-supervised learning and calibration of inference results described below. For example, self-supervised learning is a technique that allows the machine learning system 104 to learn without the need for labeled data.

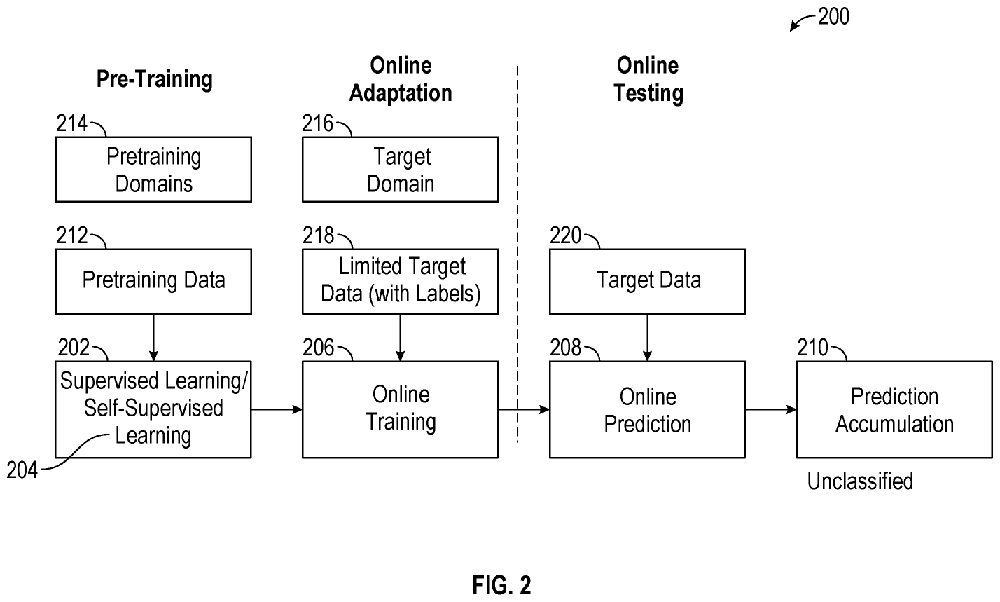

Semi-supervised learning may include a supervised learning module, a self-supervised learning module, an online training module, an online prediction module, and a prediction accumulation module (as shown in FIG. 2). The supervised learning module may be used to train the ML model 106 on labeled data. The labeled data may be data that has been annotated with labels by an expert user. The supervised learning module may use the labeled data to learn the relationship between the input data 110 and the output labels. The self-supervised learning module may be used to train the ML model 106 on unlabeled data. The unlabeled data may be data that has not been annotated with labels by an expert user.

The hybrid replay module 118 may address potential class imbalance issues, particularly for rare but important classes. The hybrid replay module 118 may address the aforementioned class imbalance issues in a number of ways, including, but not limited to: 1) by generating augmentation samples, 2) by augmenting current training batch data, and 3) by maximizing sample diversity. For example, the hybrid replay module 118 may use a variety of techniques to generate augmentation samples (e.g., augmented data 124) of the class with limited available examples. In an aspect, augmentation samples may be generated using variational autoencoders, generative adversarial networks, or traditional sample-based augmentation techniques.

ML model 106 is trained on data. If the data is incomplete or inaccurate, the corresponding model will not be able to learn accurately. One of the challenges in machine learning is that the data is often incomplete or inaccurate. The aforementioned challenges may be due to a number of factors, such as, but not limited to: infrequent examples in the training data, catastrophic forgetting, storage of large amounts of prior data, high-risk low probability events, and the like. For instance, some examples may be rare in the training data 113. Such infrequent examples may make it difficult for ML model 106 to learn to classify these examples accurately.

In an aspect, the hybrid replay module 118 may implement a method for carrying out the above examples, for example, by using a replay memory and a replay generative Artificial Intelligence (AI) architecture. The replay memory may be a data structure that stores a mixture of representative labeled samples and as-yet-unlabeled tracks (with associated metadata) in a fixed size dynamic buffer. The replay memory may be used to store the most useful and representative examples from the training data 113. The replay memory may help the ML model 106 to learn to classify new examples accurately, even when they are rare or difficult to classify. The replay memory may also propagate future class labels back through time to increase class-labeled data and supplement future batches with prior data. Such propagation may help to prevent catastrophic forgetting and improve the ML models' 106 accuracy on rare and difficult examples. Generative AI architecture is the design of a system that may generate new content or data based on existing data. This type of AI system may be trained on a large dataset of examples, and then may use that knowledge to create new outputs that are similar to the training data. In an aspect, the replay generative AI architecture may be implemented as a replay Generative Adversarial Network (GAN).

For example, the hybrid replay module 118 may combine both replay memory and replay GAN with streaming data 122, producing an extended training set that outputs data to a discriminator/classifier. The discriminator/classifier is a machine learning model that is trained to distinguish between real data and fake data generated by the replay GAN. The discriminator/classifier may also be used by the machine learning system 104 to predict the class of a data sample.

FIG. 2 is a conceptual diagram illustrating an example semi-supervised incremental learning according to techniques of this disclosure. Semi-supervised learning is a machine learning technique that uses both labeled and unlabeled data to train a model. Semi-supervised learning is often used in cases where there is limited labeled data available, but a large amount of unlabeled data. Semi-supervised incremental learning (SSIL) is a machine learning paradigm that combines the advantages of semi-supervised learning and incremental learning. In SSIL, the model may be trained on a small amount of labeled data and a large amount of unlabeled data. As the model is trained, it may learn new classes and update its knowledge base without forgetting what it has already learned. The semi-supervised learning system 200 shown in FIG. 2 may include but is not limited to the following modules: supervised learning module 202, self-supervised learning module 204, online training module 206, online prediction module 208, prediction accumulation module 210, and the like.

The supervised learning module 202 may be used to train the ML model 106 on the labeled data.

The self-supervised learning module 204 may be used to train the ML model 106 on the unlabeled data. The online training module 206 may be used to update the ML model 106 as new data becomes available. The online prediction module 208 may be used to generate predictions for new data. The prediction accumulation module 210 may combine predictions from multiple observations to improve the accuracy of the inferences. Pretraining data 212 may be input to either or both of the supervised learning module 202 or self-supervised learning module 204. The pretraining data 212 from the pretraining domains 214 may be used to train initial ML model 106. The pretraining data 212 may help to improve the performance of the ML model 106 on the target domain 216, even if there is limited labeled data available. The limited target data 218 may be input to the online training module 206.

Advantageously, the limited target data 218 may be sparsely annotated with labels by an expert user. In other words, only a small subset of the limited target data 218 needs to be labeled. The online training module 206 may then use this labeled limited target data 218 to update the ML model 106 and improve their accuracy on the target domain 216. The target data 220 may also be input to the online prediction module 208. The online prediction module 208 may use the ML model 106 to generate predictions for the new data. The prediction accumulation module 210 may combine predictions from multiple observations to improve the accuracy of the inferences. In an aspect, the prediction accumulation module 210 may combine predictions by weighting the predictions by their corresponding confidences.

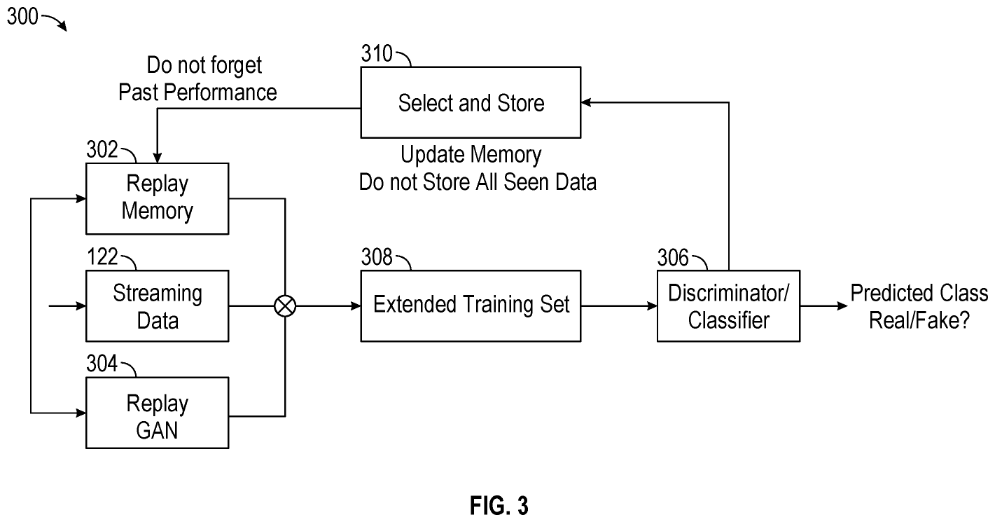

FIG. 3 is a conceptual diagram illustrating an example hybrid replay method 300 according to techniques of this disclosure. Hybrid replay module 118 implementing the hybrid replay method may address potential class imbalance issues, particularly for rare but important classes, in a number of ways.

The hybrid replay module 118 may use a variety of techniques to generate augmentation samples of the class with limited available examples. In various aspects, the hybrid replay module 118 may generate augmentation samples using variational autoencoders, GANs, or traditional sample-based augmentation techniques. For example, variational autoencoders may be used to generate new data samples that are similar to the existing data samples in the training set. GANs may be used by the hybrid replay module 118 to generate new data samples that are indistinguishable from the real data samples.

The hybrid replay module 118 may use traditional sample-based augmentation techniques to generate new data samples by applying random transformations to the existing data samples. The hybrid replay module 118 may augment the current training batch data (e.g., training data 113) with representative examples from earlier data, such as from selected component data, received from the architecture optimization module 120. Augmenting current training batch data may help to ensure that the ML model 106 is exposed to a wide variety of data, including examples of the rare but important class.

The hybrid replay module 118 may be used to maximize sample diversity and increase class balance, particularly for high-risk, low probability events because the hybrid replay module 118 may generate augmentation samples of the rare but important class, and the hybrid replay module 118 may also augment the current training batch data with representative examples from earlier data. Following is a non-limiting example of how the hybrid replay module 118 could be used to address class imbalance in a fraud detection application.

The training data 113 for the ML model 106 configured to perform fraud detection may contain a large number of non-fraudulent transactions and a small number of fraudulent transactions. Such class imbalance may make it difficult for the ML model 106 to learn to detect fraudulent transactions accurately. To address this class imbalance, the hybrid replay module 118 could be used to generate augmentation samples of fraudulent transactions (e.g., augmented data 124).

The hybrid replay module 118 may generate the augmentation samples of fraudulent transactions using a variety of techniques, such as, but not limited to, variational autoencoders, GANs, or traditional sample-based augmentation techniques.

The generated augmentation samples of fraudulent transactions could then be added to the training data 113. The generated augmentation samples would help to improve the class balance of the training data 113 and may make it easier for the ML model 106 to learn to detect fraudulent transactions accurately. In addition to generating augmentation samples, the hybrid replay module 118 could also be used to augment the current training batch data with representative examples from earlier data. Such augmentation could be done by selecting examples from earlier data that are similar to the examples in the current training batch.

In an aspect, the hybrid replay module 118 may help to ensure that the ML model 106 is exposed to a wide variety of data, including, but not limited to, examples of fraudulent transactions. As a result, the ML model 106 would be able to learn to detect fraudulent transactions more accurately.

Hybrid replay is a machine learning technique that also addresses the challenges of infrequent examples within the training data 113, catastrophic forgetting, and the need to store large amounts of prior data. In an aspect, the hybrid replay module 118 addresses the challenges of infrequent examples by using a dynamic memory repository to hold useful, representative prior examples, and by training a class-conditional generative network to supplement the memory and increase sample diversity.

Infrequent examples are examples that occur rarely in the training data 113. The infrequent samples may make it difficult for the ML model 106 to learn to classify these examples accurately. Catastrophic forgetting is a phenomenon where a machine learning model forgets what it has learned when it is trained on new data. Catastrophic forgetting may happen if the new data is very different from the data that the model was trained on originally.

In an aspect, the hybrid replay module 118 may combine replay memory 302 and a replay GAN 304. The replay memory 302 may store a mixture of representative labeled samples and as-yet-unlabeled tracks (with associated metadata) in a fixed size dynamic buffer. The replay memory 302 may be used to store the most useful and representative examples from the training data 113. The replay memory 302 may help the ML model 106 to learn to classify new examples accurately, even when they are rare or difficult to classify. The replay memory 302 may also propagate future class labels back through time to increase class-labeled data and supplement future batches with prior data. Such propagation may help to prevent catastrophic forgetting and improve the ML models' 106 accuracy on rare and difficult examples. The replay memory 302 may maintain its buffer size by clustering labeled data and preserving representative examples. The buffer may help to ensure that the replay memory 302 contains the most useful and representative examples, even as the ML model 106 learn and the training data 113 changes. The replay GAN 304 is a machine learning model that may be trained to generate new data samples that are similar to the data samples in the replay memory 302. The replay GAN 304 may be used to increase class balance between minority and majority classes and may generate high priority examples more frequently. The replay GAN 304 may also leverage an auxiliary classifier 306 to stabilize sample generation and measure sample quality compared to those present in the replay memory 302. The hybrid replay module 118 may combine the replay memory 302 and the replay GAN 304 to train the machine learning models 106. The replay memory 302 may be used to store the most useful and representative examples from the training data. The replay GAN 304 may be used to generate new data samples that are similar to the data samples in the replay memory 302. The ML model 106 may be trained on the labeled data in the replay memory 302, as well as the new data samples generated by the replay GAN 304. The ML model 106 may learn to classify the data samples accurately, even when they are rare or difficult to classify. The hybrid replay module 118 may provide a number of aforementioned benefits over traditional machine learning techniques.

In an aspect, the hybrid replay module 118 may combine both replay memory 302 and replay GAN 304 with streaming data 122, producing an extended training set 308 that outputs data to a discriminator/classifier 306. The discriminator/classifier 306 may label the data from the extended training set 308 and may predict classes as either real or fake. Further, the discriminator/classifier 306 may selectively store (select and store 310) data to update memory. Not all data may be stored. For example, only more representative data samples from real data may be stored and all fake data may be ignored. This updated memory (select and store 310) may be input to replay memory 302 for further refinement. Following is a step-by-step explanation of how the hybrid replay module 118 works with streaming data 122. First, the hybrid replay module 118 may collect and buffer streaming data 122. The streaming data 122 may be labeled or unlabeled. Second, the hybrid replay module 118 may use the replay GAN 304 to generate new data samples that are similar to the data samples in the buffer. These new data samples may be labeled or unlabeled. Third, the hybrid replay module 118 may use the discriminator/classifier 306 to label the data samples in the buffer and the generated data samples. The discriminator/classifier 306 may also selectively store (select and store 310) data to update the replay memory 302. Fourth, the hybrid replay module 118 may update the replay memory 302 with the selected and stored data 310. Not all data may be stored by the hybrid replay module 118, only the most useful and representative data. Next, the ML model 106 may be trained on the labeled data in the replay memory 302. Finally, the ML model 106 may be used to make predictions on new data. The aforementioned steps may be repeated continuously by the hybrid replay module 118, resulting in the ML model 106 configured to learn accurately from streaming data 122, even when the data is imbalanced or contains rare or difficult examples.

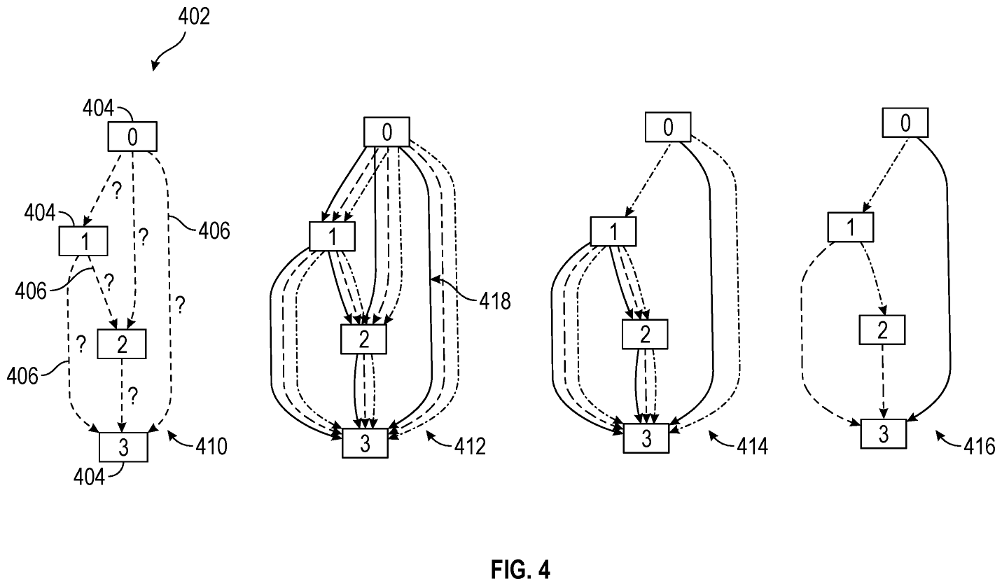

FIG. 4 is a conceptual diagram illustrating an example architecture optimization method according to techniques of this disclosure. Architecture optimization is a process of automatically adjusting the complexity of a machine learning model to improve its performance on a given task. In the context of lifelong inference, architecture optimization may be used to adapt the model to changes in the sensor data over time. Adapting models is important because the sensor data may change due to a number of factors, such as, but not limited to, changes in the environment, changes in the hardware, or changes in the software. By adapting the models of task-specific network module 116 to changes in the sensor data, the architecture optimization module 120 may help to prevent the task specific network module 116 from experiencing catastrophic forgetting. As noted above, catastrophic forgetting is a phenomenon where a machine learning model forgets what it has learned when it is trained on new data.

In the context of lifelong inference, the architecture optimization module 120 may also be used to adapt the task-specific network module 116 to different input requirements and application domain. Such adaptation may be implemented by leveraging a differentiable, weight-sharing neural architecture search (NAS) for efficiently evaluating architectural choices in parallel with online training and utilizing a cell-based approach to limit the NAS search space based on prior experience and pilot studies to begin with a limited set of high-performing modules. A differentiable, weight-sharing NAS is a type of NAS that uses gradient descent to search for the optimal architecture. Advantageously, weight-sharing NAS makes it possible to evaluate architectural choices in parallel with online training, which is important for lifelong inference because the task-specific network module 116 needs to be able to adapt to changes in the data quickly. A cell-based NAS is a type of NAS that limits the search space to a set of pre-defined cells. The cell-based NAS makes it possible to start the search with a limited set of high-performing modules, which may speed up the search process. One of the challenges in the art of architecture optimization is balancing continuous adaptation of the network architecture with growing computational complexity and time to evaluate new selections. Another challenge is that certain architectural components may be difficult to build from the neurons up in an online continuous learning setting. The architecture optimization method 120 may overcome these challenges by leveraging a differentiable, weight-sharing NAS for efficiently evaluating architectural choices in parallel with online training and utilizing a cell-based approach to limit the NAS search space based on prior experience and pilot studies to begin with a limited set of high-performing modules. The architecture optimization module 120 may have a number of benefits for lifelong inference. For example, the architecture optimization module 120 may help to prevent catastrophic forgetting by adapting the task-specific network module 116 to changes in the data over time. As another non-limiting example, the architecture optimization module 120 may improve the performance of task-specific network module 116 on rare but important events.

Progressive modularized architecture search (pNAS) is a method for architecture optimization that begins with a limited set of pre-selected modules and progressively increases the complexity of the network by adding new modules and optimizing the edges of the graph. FIG. 4 is a conceptual diagram illustrating an example of how pNAS could be used to optimize the architecture of a neural network for lifelong inference. The search space may be initialized with a limited set of pre-selected modules, such as Shaped MultiLayer Perceptions (MLPs), Shaped ResBlocks, and Graph Convolutional Networks (GCNs). Each module may have a small number of hyperparameters. The NAS space may be modeled as a directed, acyclic graph 402 of the current module candidate set. The nodes 404 of the acyclic graph 402 may represent the modules and the edges 406 of the graph 402 may represent the flow of information between the modules. At each meta-optimization step, the edges 406 of the graph 402 (mixture of modules) may be optimized. The edges 406 of the graph 402 may be optimized using a variety of methods, such as, but not limited to, gradient descent or evolutionary algorithms. If the performance of the graph 402 is not satisfactory, new nodes 404 may be added to the graph 402. It should be noted that new nodes may increase the complexity of the network. NAS optimization may be finalized via early stopping against a performance threshold. Once NAS optimization is finalized, the task-specific network module 116 may be trained on the chosen architecture. Following are some of pNAS benefits for lifelong inference. pNAS is efficient because it begins with a limited set of pre-selected modules and progressively increases the complexity of the network. Such technique makes it possible to find high-performing architectures quickly. pNAS is robust to changes in the data because it may adapt the architecture of the network to changes in the data. Such adaptation may be important for lifelong inference because the data may change over time.

The method implemented by the architecture optimization module 120 may be summarized in the following steps illustrated in FIG. 4. First, the architecture optimization module 120 may establish initial unknown operations 410 on the edges 406 of nodes 404. In other words, the architecture optimization module 120 may start with a set of pre-defined nodes (modules) 404 and may connect them with edges 406. Each edge 406 may represent an unknown operation that needs to be optimized. Second, the architecture optimization module 120 may perform continuous relaxation 412 by placing a mixture of operations 418 on each edge 406. In other words, the architecture optimization module 120 may replace each unknown operation with a mixture of all possible operations 418. Such replacement may allow the architecture optimization module 120 to optimize the architecture of the network in a continuous space. Third, the architecture optimization module 120 may bilevel optimization 414 to jointly train mixing probabilities and weights. Bilevel optimization 414 is a technique that may be used to train complex models with multiple layers of optimization. In this case, the architecture optimization module 120 may use bilevel optimization 414 to jointly train the mixing probabilities and the weights 126 of the task-specific network module 116. Fourth, the architecture optimization module 120 may finalize task-specific network module 116 based on the learned mixing and probabilities. Once the task-specific network module 116 is trained, the architecture optimization module 120 may finalize 416 the model by selecting the operations with the highest mixing probabilities. The method performed by the architecture optimization module 120 is efficient because it uses continuous relaxation 412 and bilevel optimization 414 to train the task-specific network module 116. The continuous relaxation 412 allows the architecture optimization module 120 to find high-performing architectures quickly. The method performed by the architecture optimization module 120 is robust to changes in the data because it may optimize the architecture of the task-specific network module 116 to changes in the data. This benefit is important for lifelong inference because the data may change over time. Finally, the method performed by the architecture optimization module 120 is scalable to large datasets and complex tasks because this method may optimize the architecture of the task-specific network module 116 to the specific task at hand.

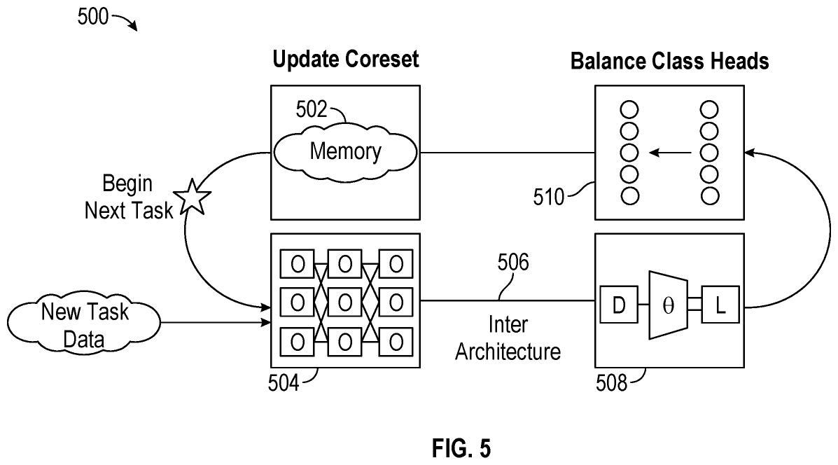

FIG. 5 is a conceptual diagram illustrating an example incremental DARTS optimization method according to techniques of this disclosure.

DARTS (Differentiable Architecture Search) is a method for NAS that uses gradient descent to optimize the architecture of a neural network. In an aspect, the architecture optimization module 120 may implement the DARTS algorithm and following is the discussion of such implementation. The architecture optimization module 120 implementing the DARTS algorithm may first define a super-model, which is a large neural network that contains all possible architectures of the desired size and complexity. The super-model may then be trained on the training dataset 113, and the gradient descent algorithm may be used to adjust the weights 126 of the super-model in such a way that the architecture of the super-model is optimized for performance on the training dataset 113. Once the super-model has been trained, the architecture optimization module 120 may use the weights 126 of the super-model to select the optimal architecture for the neural network. The architecture optimization module 120 may implement this selection by looking at the weights 126 of the super-model and identifying the operations that are most important for performance. The architecture optimization module 120 then may select a neural network architecture that contains these operations. The DARTS algorithm has a number of benefits over other NAS algorithms. DARTS is efficient because it uses gradient descent to optimize the architecture of the neural network. In other words, DARTS may find high-performing architectures quickly. DARTS is robust to changes in the training dataset because it optimizes the architecture of the neural network for performance on the training dataset. In other words, DARTS may find architectures that work well on a variety of different datasets. DARTS is scalable to large datasets and complex tasks because it may optimize the architecture of the neural network for the specific task at hand.

The architecture optimization module 120 may model the operation at each node (i.e., nodes 404 shown in FIG. 4) as a mixture of the candidate operations at that node. In other words, the operation at each node may be a weighted average of the candidate operations. The weights may be parameterized by a vector α(i;j).

DARTS algorithm may solve a bilevel optimization problem to optimize the architecture of the neural network. The bilevel optimization problem may iterate between optimizing the architecture weights w (which parameterize the candidate operations) with respect to the training data and optimizing the mixture weights α (which parameterize the weighting of the candidate operations) with respect to holdout data. Following is a more detailed explanation of the bilevel optimization problem. First, DARTS algorithm may optimize the architecture weights w with respect to the training data. Such optimization may be done by training the super-model on the training dataset. Next, DARTS algorithm may optimize the mixture weights α with respect to the holdout data. Such optimization may be performed by training the super-model on the holdout dataset but using a different loss function. The loss function used to train the mixture weights may be designed to encourage the super-model to learn mixtures of the candidate operations that are useful for performance on holdout data. The aforementioned steps may be repeated until the architecture weights w and the mixture weights α converge. The resulting architecture weights and mixture weights may define the optimal architecture for the neural network. The bilevel optimization problem is challenging to solve, but DARTS algorithm may use a number of techniques to make it more efficient. For example, DARTS algorithm may use a gradient descent algorithm that is specifically designed for bilevel optimization. Additionally, DARTS algorithm may use a number of heuristics to reduce the search space of the bilevel optimization problem. DARTS has been shown to be effective at finding high-performing neural network architectures for a variety of different tasks. For example, DARTS has been used to find architectures for image classification, object detection, and natural language processing.

At the end of the DARTS training, the architecture optimization module 120 may infer a discrete architecture using the argmax of the α (i.e., only the o(i;j) at each (i; j) with the highest corresponding α(i;j) is retained). In other words, the architecture optimization module 120 may select the operation with the highest weight at each node of the neural network.

In an aspect, the architecture optimization module 120 may implement a variant of the DARTS algorithm, namely I-DARTS. FIG. 5 illustrates a method 500 of implementation of the I-DARTS algorithm by the architecture optimization module 120. An intuitive technique for an incremental variant of DARTS might be to simply run the DARTS algorithm including a coreset of exemplar data for replay. However, this technique would not take advantage of the numerous advancements in incremental learning which far exceed simple replay data. I-DARTS proposes a strong incremental learning variant of DARTS by leveraging a dynamic memory repository (DMR) 502 to hold useful, representative prior examples. The DMR 502 is a data structure that may store and retrieve data efficiently. The DMR 502 may also be able to learn over time, so it may identify the most useful and representative examples. In an aspect, the architecture optimization module 120 may use the DMR 502 to store a coreset of exemplar data, as well as other important examples from the past.

In class-incremental learning (CIL), the task-specific network module 116 may be trained on a series of tasks, where each task has a different set of classes. The task-specific network module 116 should be able to learn the new classes without forgetting the classes that it has already learned. One of the challenges of CIL is catastrophic forgetting. Catastrophic forgetting occurs when the machine learning models forget what they have learned when the machine learning models are trained on new data. Catastrophic forgetting may happen if the new data is very different from the data that the machine learning models were trained on originally. One way to address catastrophic forgetting is to use prediction space regularization. Prediction space regularization may encourage the task-specific network module 116 to learn the new classes without unlearning the representation of the classes that it has already learned. Prediction space regularization may be performed by penalizing the task-specific network module 116 for making changes to its predictions for the old classes. Such penalizing may be implemented by using a loss function that compares the predictions of task-specific network module 116 for the old classes on the new data to the predictions of task-specific network module 116 for the old classes on the old data. Model space regularization is another way to address catastrophic forgetting. Model space regularization may penalize task-specific network module 116 for making changes to the weights 126. Such penalizing may be performed by using a loss function that compares weights 126 of the task-specific network module 116 on the new data to the weights 126 on the old data.

In the context of class-incremental learning (CIL), knowledge distillation (KD) is a technique that may be used to transfer knowledge from an old model to a new model. The old model may be trained on the data from previous tasks, while the new model may be trained on the data from the current task. KD may be performed by forcing the new model to produce predictions that are similar to the predictions of the old model. Such predictions may be achieved by using a loss function that compares the predictions of the two models. One way to use KD in CIL is to distill knowledge from the old model to the new model on all of the data, including the data from previous tasks, for example, by adding a KD loss term to the loss function of the new model.

Still referring to FIG. 5, the architecture optimization module 120 may first train a super model 504 on all of the tasks using the bilevel DARTS optimization. The DARTS optimization process described above involves searching for the optimal architecture for the super-model by alternately training the super-model to minimize the loss function and updating the architecture to improve the performance of the super-model 504. Once the super-model 504 has been trained, the architecture optimization module 120 may then infer the optimal architecture for the current task 506 from the super-model 504. In an aspect, the architecture optimization module 120 may implement this step by selecting the architecture that has the highest performance on the current task. The architecture optimization module 120 may retrain the optimal architecture 508 of the task-specific network module 116 on all of the training data for the current task, including the coreset. The retraining step 508 may help to fine-tune the architecture for the specific task. In addition, the architecture optimization module 120 may apply a class-balancing fine-tuning stage 510 to remove bias in the classification heads. In an aspect, the architecture optimization module 120 may implement this step by adjusting the weights of the classification heads so that each class has an equal chance of being predicted. Finally, the architecture optimization module 120 may update the coreset that may be stored in DMR 502 to best represent the prior task training data. In an aspect, the architecture optimization module 120 may select a subset of the training data 113 that is most representative of the prior task. In an aspect, the steps shown in FIG. 5 may be repeated until all of the tasks have been visited. I-DARTS is a powerful incremental learning algorithm that may be used to train a single neural network architecture to perform multiple tasks in a sequential manner. I-DARTS has been shown to achieve state-of-the-art results on a variety of incremental learning benchmarks.

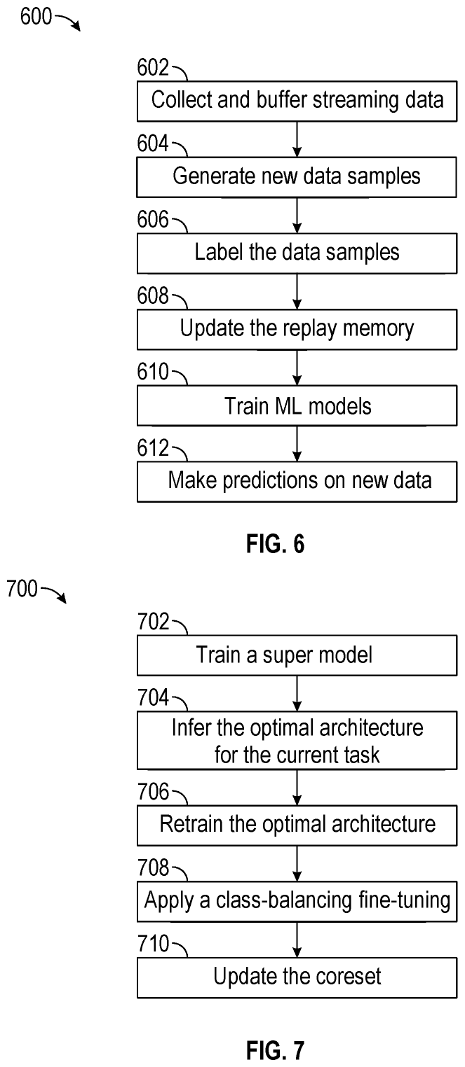

FIG. 6 is a flowchart illustrating an example mode of operation for a hybrid replay module 118, according to techniques described in this disclosure. Although described with respect to computing system 100 of FIG. 1 having processing circuitry 143 that executes hybrid replay module 118, mode of operation 600 may be performed by a computation system with respect to other examples of machine learning systems described herein.

In mode operation 600, processing circuitry 143 executes hybrid replay module 118. Hybrid replay module 118 may collect and buffer streaming data (602). The streaming data may be labeled or unlabeled. Hybrid replay module 118 may use the replay GAN to generate new data samples that are similar to the data samples in the buffer (604). These new data samples may be labeled or unlabeled. Hybrid replay module 118 may use the discriminator/classifier to label the data samples in the buffer and the generated data samples (606). The discriminator/classifier may also selectively store data to update the replay memory. Hybrid replay module 118 may update the replay memory with the selected and stored data (608). Not all data may be stored by the hybrid replay module 118, only the most useful and representative data. Next, the machine learning models 106 may be trained on the labeled data in the replay memory (610). Finally, the machine learning models 106 may be used to make predictions on new data (612).

FIG. 7 is a flowchart illustrating an example mode of operation for an architecture optimization module 120 implementing I-DARTS algorithm, according to techniques described in this disclosure. Although described with respect to computing system 100 of FIG. 1 having processing circuitry 143 that executes architecture optimization module 120, mode of operation 700 may be performed by a computation system with respect to other examples of machine learning systems described herein.

In mode of operation 700, processing circuitry 143 executes the architecture optimization module 120. Architecture optimization module 120 may first train a super model on a plurality of candidate tasks using the bilevel DARTS optimization (702). Once the super-model has been trained, architecture optimization module 120 may then infer the optimal architecture for the current task from the super-model (704). Architecture optimization module 120 may retrain the optimal architecture of the task-specific network module 116 on all of the training data for the current task, including the coreset (706). Next, architecture optimization module 120 may apply a class-balancing fine-tuning stage to remove bias in the classification heads (708). Finally, architecture optimization module 120 may update the coreset that may be stored in DMR to best represent the prior task training data (710).

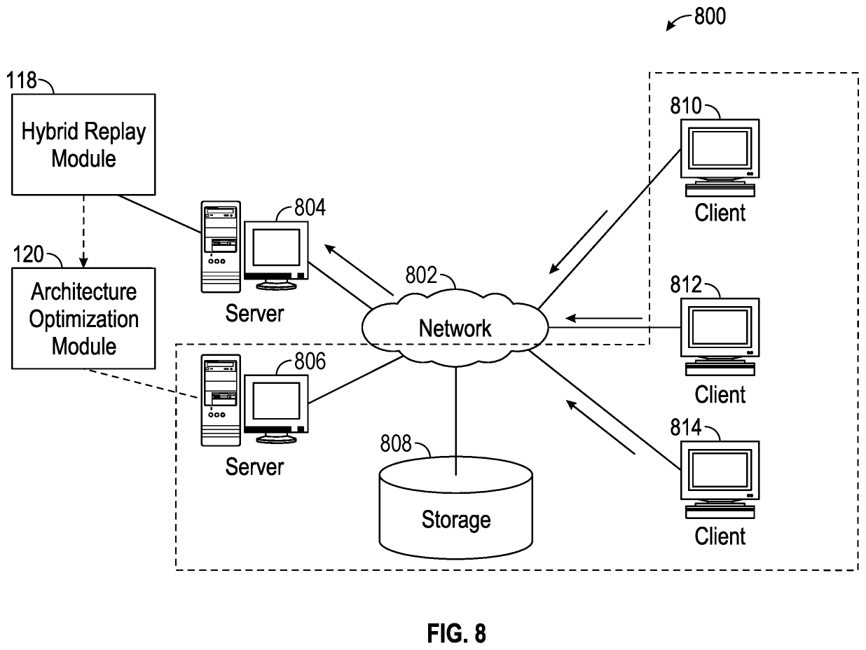

FIG. 8 is an example diagram of a distributed data processing system in which aspects of the illustrative technique may be implemented. Distributed data processing system 800 may include a network of computers in which aspects of the illustrative embodiments may be implemented. The distributed data processing system 800 may contain at least one network 802, which is the medium used to provide communication links between various devices and computers connected together within distributed data processing system 800. The network 802 may include connections, such as wire, wireless communication links, or fiber optic cables.

In the depicted example, server 804 and server 806 are connected to network 802 along with storage unit 808. In addition, clients 810, 812, and 814 are also connected to network 802. These clients 810, 812, and 814 may be, for example, personal computers, network computers, or the like. In the depicted example, server 804 provides data, such as live streaming transaction data (streaming data 122) to the clients 810, 812, and 814. Clients 810, 812, and 814 are clients to server 804 in the depicted example. Distributed data processing system 800 may include additional servers, clients, and other devices not shown.

In the depicted example, distributed data processing system 800 is the Internet with network 802 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 800 may also be implemented to include a number of different types of networks, such as for example, an intranet, a local area network (LAN), a wide area network (WAN), or the like. As stated above, FIG. 8 is intended as an example, not as an architectural limitation for different aspects of the present disclosure, and therefore, the particular elements shown in FIG. 8 should not be considered limiting with regard to the environments in which the illustrative aspects of the present disclosure may be implemented.

As shown in FIG. 8, one or more of the computing devices, e.g., server 804, may be specifically configured to implement a hybrid replay module 118 and an architecture optimization module 120 in accordance with one or more aspects previously described. The hybrid replay module 118 may operate in the manner as described above with regard to FIG. 3, and the architecture optimization module 120 may operate in the manner as described above with regard to FIG. 5, in one or more illustrative aspects. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as server 904, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative aspects.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in computer-readable media, such as a computer-readable storage medium, containing instructions. Instructions embedded or encoded in one or more computer-readable storage mediums may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A system comprising:
processing circuitry in communication with storage media, the processing circuitry configured to execute a machine learning system comprising at least a first module, a second module and a third module, wherein the machine learning system is configured to train one or more machine learning models and wherein:
the first module is configured to generate augmented input data based on streaming input data;
the second module comprises a machine learning model configured to perform a specific task based at least in part on the augmented input data; and
the third module configured to adapt a network architecture of the one or more machine learning models based on changes in the streaming input data.

2. The system of claim 1, wherein the streaming input data comprises streaming input data having a class imbalance among a plurality of classes represented in the streaming input data.

3. The system of claim 1, wherein the augmented input data comprises one or more augmentation samples of a minority class.

4. The system of claim 1, wherein the machine learning system is configured to train the one or more machine learning models using one or more semi-supervised incremental learning techniques.

5. The system of claim 1, further comprising one or more modules configured to process the streaming input data by performing at least one of: a format transformation operation, a metadata derivation operation, or a data association operation.

6. The system of claim 1,
wherein the first module further comprises a Dynamic Memory Repository (DMR), a replay generative Artificial Intelligence (AI) architecture and a discriminator/classifier,
wherein the DMR is configured to selectively store one or more representative data samples,
wherein the generative AI architecture is configured to generate one or more new data samples that are similar to the one or more representative data samples stored in the DMR, and
wherein the discriminator/classifier is configured to distinguish between real data and fake data in the one or more new data samples generated by the generative AI architecture.

7. The system of claim 6, wherein the discriminator/classifier is further configured to select one or more new data samples to be stored in the DMR.

8. The system of claim 1, wherein the third module is further configured to train a super-model on a plurality of candidate tasks using at least one of a training data set and input streaming data and is configured to infer an optimal architecture for a current task based on the trained super-model.

9. The system of claim 8, wherein the third module is further configured to optimize one or more architecture weights with respect to the training data.

10. A method comprising:
generating, using a first module, augmented input data based on streaming input data;
performing, using a second module comprising a machine learning model, a specific task based at least in part on the augmented input data; and
adapting, using a third module, a network architecture of the one or more machine learning models based on changes in the streaming input data.

11. The method of claim 10, wherein the streaming input data comprises streaming input data having a class imbalance among a plurality of classes represented in the streaming input data.

12. The method of claim 10, wherein the augmented input data comprises one or more augmentation samples of a minority class.

13. The method of claim 10, wherein the machine learning system is configured to train the one or more machine learning models using one or more semi-supervised incremental learning techniques.

14. The method of claim 10, further comprising:
processing, using one or more modules, the streaming input data by performing at least one of: a format transformation operation, a metadata derivation operation, or a data association operation.

15. The method of claim 10, further comprising:
selectively storing in a Dynamic Memory Repository (DMR) one or more representative data samples;
generating, using a generative Artificial Intelligence (AI) architecture, one or more new data samples that are similar to the one or more representative data samples stored in the DMR, and
distinguishing, using a discriminator/classifier, between real data and fake data in the one or more new data samples generated by the generative AI architecture.

16. The method of claim 15, further comprising:
selecting, using the discriminator/classifier, one or more new data samples to be stored in the DMR.

17. The method of claim 10, further comprising:
training, using the third module, a super-model on a plurality of candidate tasks using at least one of a training data set and input streaming data and
inferring an optimal architecture for a current task based on the trained super-model.

18. The method of claim 17, further comprising:
optimizing, using the third module, one or more architecture weights with respect to the training data.

19. Non-transitory computer-readable media having instructions encoded thereon, the instructions configured to cause processing circuitry to:
generate, using a first module, augmented input data based on streaming input data;
perform, using a second module comprising a machine learning model, a specific task based at least in part on the augmented input data; and
adapt, using a third module, a network architecture of the one or more machine learning models based on changes in the streaming input data.

20. The non-transitory computer-readable media of claim 19, wherein the streaming input data comprises streaming input data having a class imbalance among a plurality of classes represented in the streaming input data.
